(19) United States
(12) Patent Application Publication
(10) Pub. No.: US 2008/0149524 A1
(43) Pub. Date: Jun. 26, 2008

(54) FOOD CONTAINERS INCLUDING DENTAL CLEANING DEVICES AND OTHER PERSONAL CARE ITEMS

(76) Inventor: William B. Rademaker, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/041,544

(22) Filed: Mar. 3, 2008

Related U.S. Application Data
(63) Continuation-in-part of application No. 10/811,503, filed on Mar. 26, 2004.
(60) Provisional application No. 60/458,703, filed on Mar. 27, 2003.

(51) Int. Cl. A61C 15/04; A45C 11/20

(52) U.S. Cl. 206/542; 132/324

(57) ABSTRACT

The present invention is directed to food product containers comprising one or more dental cleaning devices, such as dental floss, toothpicks, and plaque-removing strips. The dental cleaning device may be disposed in a packet. The food product container may further comprise additional cleaning devices, breath freshening devices, and text or messages, such as advertisements.

### CROSS-REFERENCE TO RELATED APPLICATION

This application is a continuation-in-part of U.S. Application Ser. No. 10/811,503, filed Mar. 26, 2004, which claims the benefit of U.S. Provisional Application No. 60/458,703, filed Mar. 27, 2003, the disclosures of which are hereby expressly incorporated by reference.

### FIELD OF THE INVENTION

The following disclosure relates generally to food product containers and, more particularly, to commercial food product containers.

### BACKGROUND OF THE INVENTION

A multitude of food product containers exists for selling and distributing various types of food products. For example, some commercial food products sold in convenience stores are enclosed in see-through plastic bags so that customers may view the food before purchasing the product. In addition, food products sold for immediate consumption at movies, sports events, and other venues are often sold in paper or cardboard containers (e.g., paper bags, cardboard buckets, etc.). In addition to the foregoing, fast food outlets typically place food products (e.g., hamburgers and French fries) in paper bags or other similar containers for distribution to their customers.

### SUMMARY OF THE INVENTION

The present invention is directed to food product containers comprising one or more dental cleaning devices. Exemplary dental cleaning devices used in accordance with the invention include, but are not limited to, dental floss, tooth picks, and plaque-removing strips. The food product container may comprise more than one dental cleaning device. For example, the food product container may contain at least two different dental cleaning devices. The dental cleaning device may be disposed in a packet. In some embodiments, a dental cleaning device, or a packet containing a dental cleaning device, is attached to the inside or the outside of the food product container. For example, a dental cleaning device, or a packet containing a dental cleaning device, may be releasably attached to the outside of the food product container. In other embodiments, a dental cleaning device, or a packet containing a dental cleaning device, is securely attached to the food product container. In some embodiments, a dental cleaning device, such as tooth floss, is disposed in the food container.

In addition to the dental cleaning device, the food product container may further comprise one or more other cleaning devices, such as a hand towel or a face towel. The food product container may also further comprise a breath freshening device, such as mints or mouthwash.

In some embodiments, the food product container also includes text, such as advertising text, or other textural or graphical messages positioned near the dental cleaning device. Similarly, a packet containing a dental cleaning device may additionally include such text or messages. For example, the food container or packet containing a dental cleaning device may include advertising text indicating the source or sponsorship of the dental cleaning device.

The food product container may further comprise food at least partially held within the food product container. Exemplary foods include, but are not limited to, fast food, such as popcorn, sandwiches, hot dogs, hamburgers, pizza, etc.

In accordance with another embodiment, a popcorn container assembly is provided. The assembly generally includes a disposable, open-ended popcorn container having a rim and an upper, open end that is not closable, wherein the container is designed and configured to enclose or support popcorn. The assembly further includes a dental flossing device longitudinally extending along at least a portion of the container proximal to the rim of the container, such that the user can conveniently use the dental floss to clean the popcorn lodged between the user's teeth during or immediately after eating the popcorn to provide quick and easy dental hygiene for the user at the location of popcorn consumption. The assembly further includes popcorn at least partially disposed within the container.

In accordance with another embodiment, a food container assembly is provided. The assembly generally includes a disposable food container having an edge and an upper, open end, wherein the container is designed and configured to enclose or support food. The assembly further includes a dental flossing device longitudinally extending along at least a portion of the edge of the container, such that the user can use the dental flossing device to clean food lodged between the user's teeth during or immediately after eating the food at the location of food consumption, wherein the dental flossing device is the edge of the container. The assembly further includes food at least partially disposed within the container.

In accordance with another embodiment, a food container assembly is provided. The assembly generally includes a disposable, open-ended fast food container having an edge and an upper, open end that is not closable, wherein the container is designed and configured to enclose or support fast food and wherein the fast food is of the type sold for immediate consumption and, when consumed, has a tendency to get lodged between a user's teeth. The assembly further includes at least a portion of a strand of dental floss longitudinally extending along at least a portion of the container proximal to the edge of the container, such that the user can use the strand of dental floss during or immediately after eating the fast food at the location of fast food consumption. The assembly further includes perishable fast food at least partially disposed within the fast food container.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an isometric view of a food product container including a dental cleaning device in accordance with an embodiment of the invention.

FIG. 2 is an enlarged isometric view of the dental cleaning device of FIG. 1 and an associated packet in accordance with an embodiment of the invention.

FIG. 3 is an isometric view of a food product container and a dental cleaning device in accordance with another embodiment of the invention.

FIG. 4 is an isometric view of another food product container having a dental cleaning device in accordance with an embodiment of the invention.

FIG. 5 is an isometric view of a further food product container having a dental cleaning device in accordance with yet another embodiment of the invention.

FIG. 6 is an isometric view of yet another food container having a dental cleaning device in accordance with a further embodiment of the invention.

FIG. 7 is an isometric view of yet another food product container having a dental cleaning device in accordance with a further embodiment of the invention.

FIG. 8 is an isometric view of yet another food product container having a dental cleaning device in accordance with a further embodiment of the invention.

FIGS. 9-12 are isometric views of other food product containers having dental cleaning devices in accordance with other embodiments of the invention.

### DETAILED DESCRIPTION OF THE PREFERRED EMBODIMENT

The following disclosure is directed to food product containers that may include teeth cleaning devices and personal care items for the convenience of the consumer. The following description provides specific details and an enabling description for a thorough understanding of embodiments of the invention. One of ordinary skill in the relevant art will understand, however, that the invention may be practiced without some of these details. In other instances, well-known structures and functions have not been shown or described in detail below to avoid unnecessarily obscuring the description of the embodiments of the invention.

Unless specifically defined herein, all terms used herein have the same meaning as they would to one skilled in the art of the present invention.

As used herein, the term “food product container” or “food container” refers to any container suitable for enclosing or supporting a food product, groceries, or other provisions, including, but not limited to paper bags, such as brown paper bags used at checkout counters at grocery stores or that can be bought in bulk, lunch bags, plastic bags, cardboard containers, foil containers, trays or other devices for supporting a food product, and candy wrappers. The term “food product” refers to any liquid or solid consumable product.

As used herein, the term “cleaning device” refers to any device used to clean parts of a body that may be soiled after consuming a food product. For example, a “dental cleaning device” refers to any device used to clean teeth, including, but not limited to, dental floss, tooth picks, plaque-removing strips, pipe cleaner-type devices that can clean between braces, tongue-cleaning devices, or sugar-neutralizing agents (solid or liquid). Other cleaning devices that may be used according to the invention include, but are not limited to, hand or face towels, which may be pre-moistened and which may have a cleaning agent pre-applied to them. The term “breath freshening device” refers to any solid or liquid device that can be used to freshen breath. Exemplary breath freshening devices include, but are not limited to, mints, mouthwash, and gum.

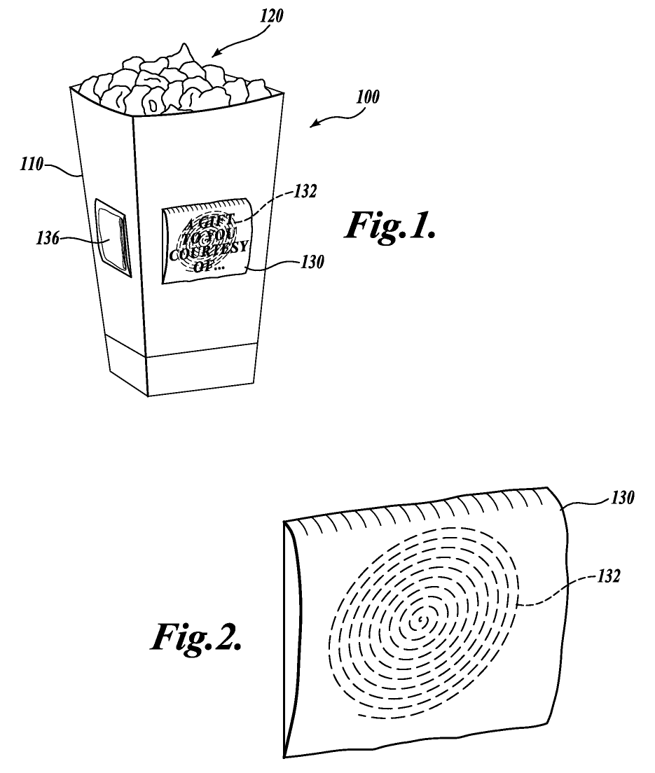

FIG. 1 is an isometric view of a commercial food product 100 including a dental cleaning device 132 in accordance with an embodiment of the invention. In one aspect of this embodiment, the commercial food product 100 includes food 120 held in a container 110. For example, in one embodiment, the commercial food product 100 may include popcorn held in a bag or other container, such as served at a movie theater or other venue. In this embodiment, the container 110 can be fabricated from paper and/or cardboard materials, among others. In another aspect of this embodiment, a packet 130 holding the dental cleaning device 132 is releasably attached to an exterior portion of the container 110. The packet may be any kind of container, sachet, envelope, box, or other type of packaging suitable for partially or completely enclosing the dental cleaning device. The dental cleaning device 132 may be dental floss or a similar device configured to remove unwanted and annoying food particles, e.g., popcorn, from between teeth.

In yet another aspect of this embodiment, the packet 130 may be attached to the container 110 with an adhesive or other suitable bonding agent. Further, the packet 130 or the container 110 may include advertising or other textural or graphical messages. Such messages may include advertising slogans and other messages configured to foster goodwill or customer brand loyalty. Similarly, such messages may include popular trivia, quizzes, or other types of games. Although the illustrated embodiment depicts popcorn in a movie theater setting, in other embodiments, other types of foods and other types of food containers may include a dental cleaning device in accordance with other embodiments of the invention. Such food containers may include text, such as advertising text, or other textural or graphical messages positioned near the dental cleaning device. For example, the food container may include advertising text indicating the source or sponsorship of the dental cleaning device. Moreover, in other embodiments the dental cleaning device, or a packet containing the dental cleaning device, may be attached to the inside of the container.

One feature of aspects of the invention illustrated in FIG. 1 is that the dental cleaning device 132 is readily accessible by consumers of the food product 100 immediately after consuming the food 120. For example, in a movie theatre setting, the present invention enables a customer to quickly and easily remove annoying popcorn from between his or her teeth without enduring the distraction for the entire movie.

In a further aspect of this embodiment, the food product 100 may also include an additional cleaning device 136 attached to the food container 110. In one aspect of this embodiment, the cleaning device 136 may include a towel, such as a pre-moistened hand towel having a cleanser pre-applied. In another aspect of this embodiment, such a cleaning device may be utilized after consuming contents of the container 110 to clean face and hands. In additional embodiments, the additional cleaning device 136 may be the same as or similar to the dental cleaning device 132. In other embodiments, the food product 100 may include three or more cleaning devices.

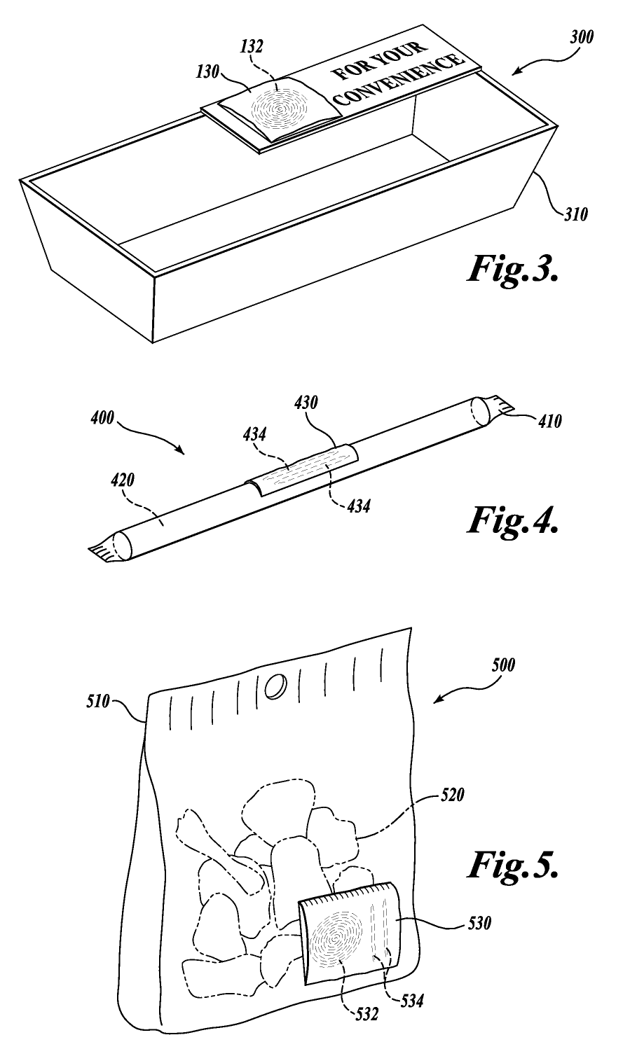

FIG. 2 is an enlarged isometric view of the packet 130 of FIG. 1 in accordance with an embodiment of the invention. In one aspect of this embodiment, the dental cleaning device 132, e.g., dental floss, may be hermetically sealed within the packet 132 prior to opening by the user. In one embodiment, the packet 132 may be transparent. In other embodiments, other types of packets can be used. For example, in one other embodiment, the packet may be paper. Accordingly, the present invention is not limited to clear plastic or paper packets, but rather, the present invention extends to any type of packet that can be attached to a food container to hold a cleaning device in accordance with this disclosure. As mentioned above, the packet 130 may be attached to the container 110 with a suitable adhesive or a fastener.

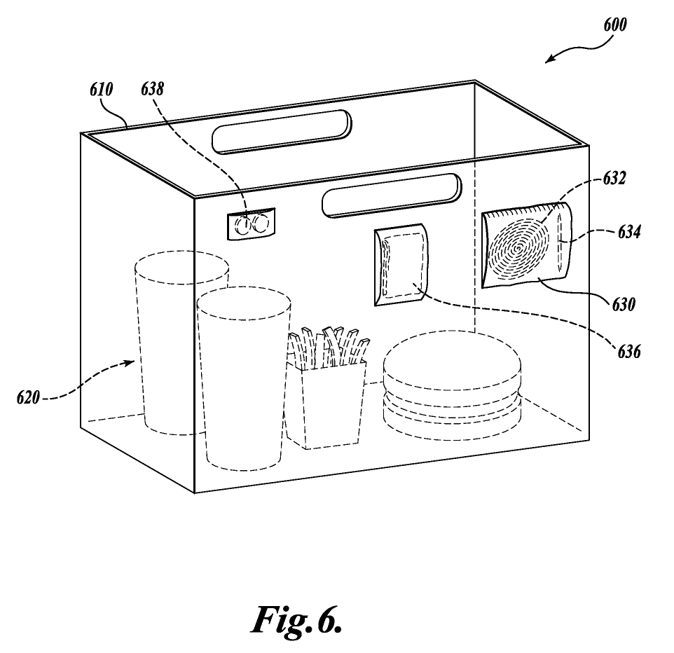

The present invention is not limited to the particular embodiment described above. Accordingly, in other embodiments, other dental cleaning devices may be combined with other types of food containers without departing from the spirit or scope of the present disclosure. For example, FIG. 3 is an isometric view of a food product 300 including a food container 310 in accordance with an embodiment of the invention. In one aspect of this embodiment, the food product 300 may be a fast food item such as a sandwich, hamburger, or hot dog distributed to a customer in a cardboard box or other container 310. In another aspect of this embodiment, the packet 130 may be attached to an exterior portion of the food container 310, such as a top portion as illustrated in FIG. 3. Accordingly, persons buying food products at fast food restaurants and other outlets can utilize the dental cleaning device 132 after consuming their meal to provide quick and easy dental hygiene.

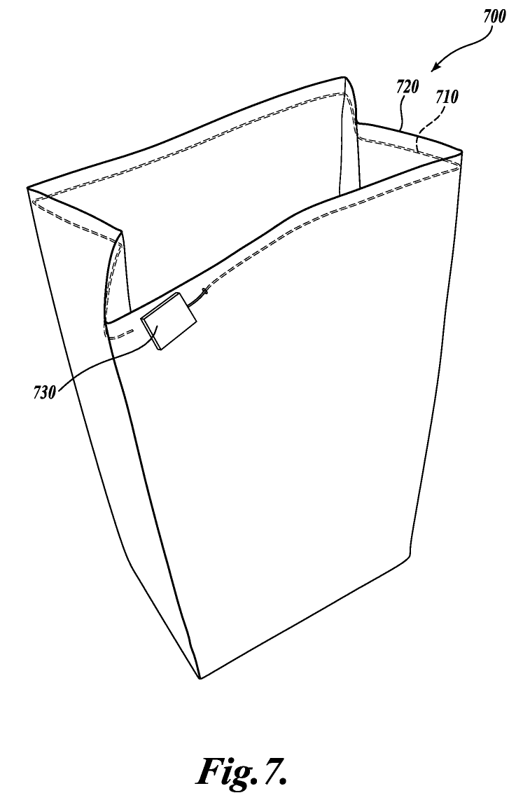

FIG. 4 is an isometric view of yet another food product 400 having a dental cleaning device 434 configured in accordance with another embodiment of the invention. In one aspect of this embodiment, the food product 400 may include a food 420, such as a pepperoni stick, beef jerky, or other similar item, removably enclosed in an airtight plastic or foil container 410. In another aspect of this embodiment, the dental cleaning device 434 may include toothpicks or other rigid or semi-rigid cleaning devices contained in a packet 430 attached to the food container 410. While toothpicks 434 are depicted in this embodiment, in other embodiments, other dental cleaning devices may be releasably attached to the container 410 for use by the consumer of the food product 420. For example, in another embodiment, the packet 430 may contain dental floss. In another embodiment, the packet 430 may include a combined dental floss/toothpick instrument. In yet other embodiments, other cleaning devices may be included. For example, a sugar-neutralizing food or liquid may be attached to a container comprising a sugar-containing food product, such as a candy wrapper.

In yet other embodiments of the inventions disclosed herein, other useful items may be attached to food containers for use by consumers of the food. For example, in another embodiment, any of the food containers disclosed herein may include packets holding breath mints or other devices for providing fresh breath after consuming the enclosed food product. For example, in one embodiment, two breath mints can be attached to any one of the food devices for consumption after the food has been consumed. In yet other embodiments, a breath-freshening liquid, such as a small vessel or container of mouthwash, may be attached to the food package for similar use.

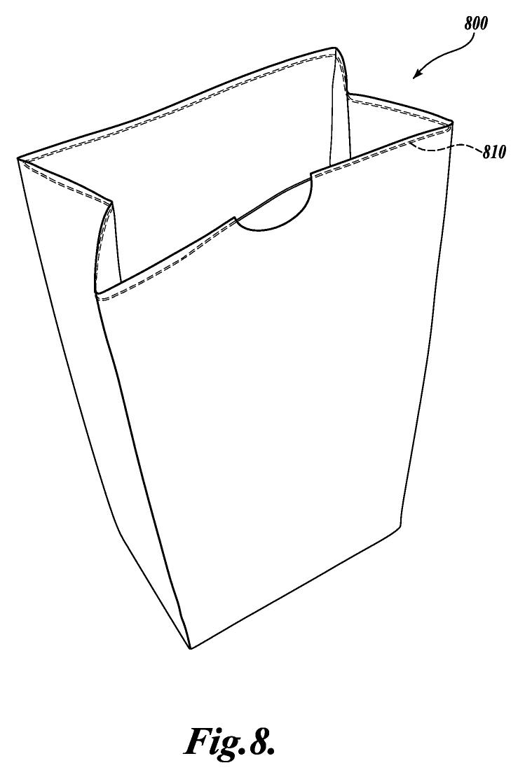

FIG. 5 is an isometric view of a further food product 500 contained in a package 510 in accordance with a further embodiment of the invention. In one aspect of this embodiment, a packet 530 attached to the container 510 includes a first dental cleaning device 532 and a second dental cleaning device 534. In another aspect of this embodiment, the container 510 may hold food 520, such as beef jerky or another similar food item that is prone to lodging between teeth during consumption. In a further aspect of this embodiment, the first dental cleaning device 532 may be dental floss and the second dental cleaning device 534 may include toothpicks. Accordingly, after enjoying the bag of beef jerky or other food, the user can access one or more of these dental cleaning devices 532 and 534 to remove annoying pieces of food from his or her teeth.

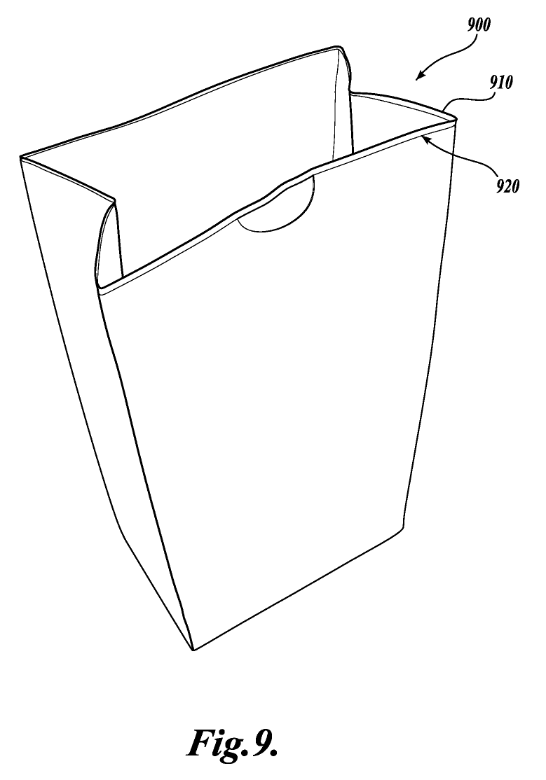

FIG. 6 is an isometric view of still another food product 600 having a container 610 in accordance with an embodiment of the invention. In one aspect of this embodiment, the food product 600 may include fast food, such as French fries and burgers 620, purchased from a fast food establishment. In another aspect of this embodiment, a packet 630 holding at least first and second dental cleaning devices 632 and 634 may be releasably attached to the container 610. Upon consuming the contents of the container 610, the diners may elect to use either the first dental cleaning device 632 or the second dental cleaning device 634 to suitably clean their teeth. In addition, as mentioned above, the container 610 may also include pre-moistened hand wipes or other hand and facial cleaning devices 636, as well as various types of breath freshening devices 638.

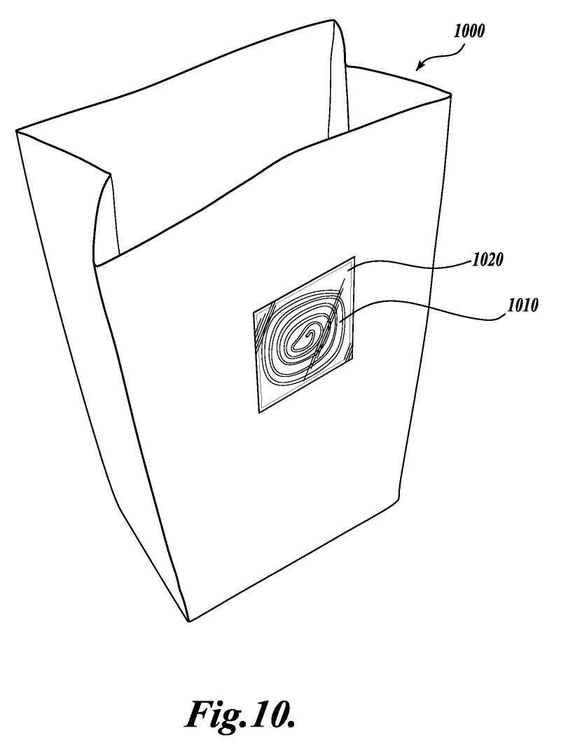

FIG. 7 is an isometric view of another food product container 700 having a dental cleaning device 710 configured in accordance with another embodiment of the invention. In one aspect of this embodiment, the dental cleaning device 710 may be releasably secured around the rim 720 of container 700, from which it may be unwound by pulling on pull tab 730. In other aspects of this embodiment, the dental cleaning device is releasably attached to container 700 under a flap that can be opened to reveal the attached dental cleaning device 710. In further aspects, the dental cleaning device 710 may also be tucked into folds or creases at the bottom of container 700.

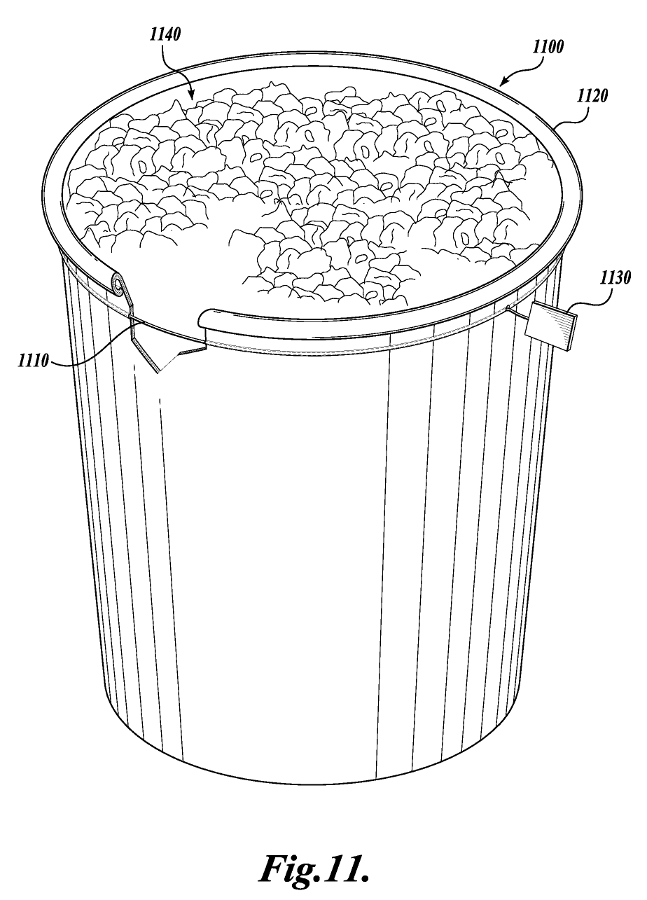

FIG. 8 is an isometric view of another food product container 800 having a dental cleaning device 810 configured in accordance with another embodiment of the invention. In one aspect of this embodiment, the dental cleaning device 810 is secured around rim 820 of container 800, allowing rim 820 of container 800 to be used to clean teeth. Alternatively, the dental cleaning device 810 may be torn off the container 800.

In a further embodiment, a dental cleaning device, for example a piece of dental floss, may be loosely disposed inside a food product container. In one aspect of this embodiment, a packet containing a piece of dental floss may be placed inside a food product container. One example includes placing a toothpick or dental floss inside a box of popcorn.

One feature of aspects of the invention described above with reference to FIGS. 1 through 8 is that inclusion of the various personal items described above can foster goodwill with purchasers of the related food items. For example, if a customer has a choice between selecting a food product container, such as a bag of popcorn, that includes dental floss or other personal cleaning items, or selecting another food product container that does not include any such item, the customer may be inclined to purchase the food product container having one or more of the aforementioned personal items. By adding to the customer's convenience and enhancing the customer's experience, one or more of the inventions described above can be useful for developing brand loyalty or otherwise cultivating commercial sales.

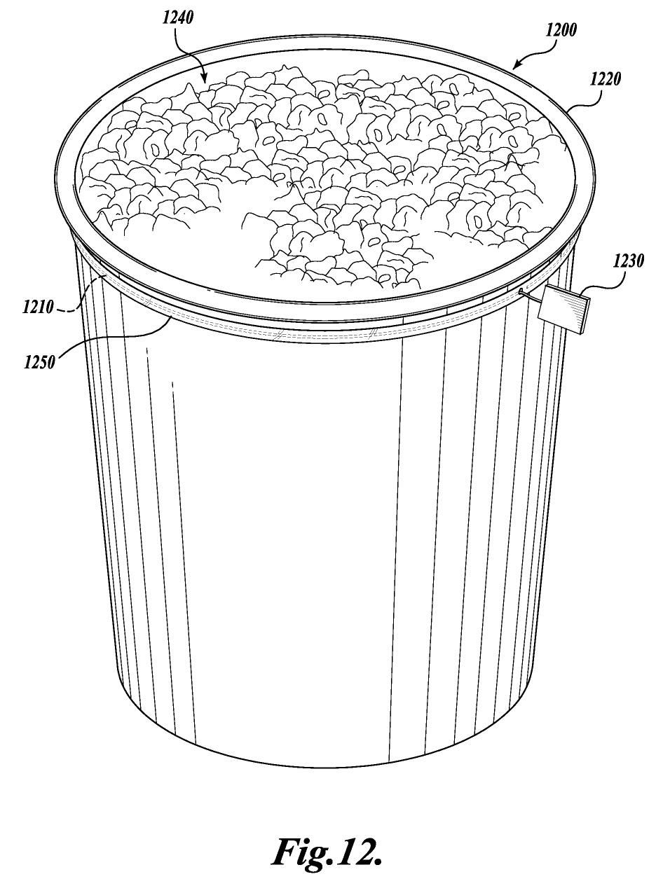

With reference to FIGS. 9-12, additional embodiments of the invention will now be described. These embodiments are substantially similar to the embodiments described with reference to FIGS. 1-8, except for differences regarding the type of container and the location and configuration of the dental cleaning device.

Referring now to FIG. 9, in another embodiment of the invention, the dental cleaning device 910 is the edge or rim 920 of the container 900. In that regard, the dental cleaning device 910 is attached to the container 900 and longitudinally extends along at least a portion of the edge 920 of the container 900 such that it is the edge 920 of the container 900. Suitable dental cleaning devices for this embodiment include dental floss or dental tape, such as GLIDE® brand dental tape, manufactured by PROCTER & GAMBLE® under the CREST® brand, and SATINFLOSS® brand dental floss and SATINTAPE® brand dental tape, both manufactured by ORAL-B®. It should be appreciated that the dental cleaning device 910 is integrated into the container structure at the edge of the container, for example, by adhesive or heat melting, or by other suitable manufacturing integration means.

It should further be appreciated that the dental cleaning device 910 is configured to be the rim 920 of the container 900, such that a user can conveniently locate the dental cleaning device 910, for example, by touch of a hand and without having to look for the dental cleaning device to locate it. Such configuration is convenient in dark venues, such as movie theatres. For example, if a viewer is watching a movie and eating popcorn, the dental cleaning device 920 is conveniently locatable and usable without interruption to the viewer's movie experience. In addition, because the dental cleaning device 910 of this embodiment does not require the unwrapping of wrappers or packaging (which tend to make noise) to access the dental cleaning device, the act of cleaning one's teeth can be completed with minimal interruption to others watching the movie.

It should be appreciated that the dental cleaning device 910 of this embodiment may be covered by a protective covering, such as a pressed plastic or tape covering to preserve the hygiene of the dental cleaning device.

Referring now to FIG. 10, in another embodiment of the invention, the dental cleaning device 1010 is attached to the container 1000 by a sealed pocket 1020. In the illustrated embodiment, the dental cleaning device 1010 is attached in a wound configuration to fit inside a substantially square-shaped pocket. However, it should be appreciated that the dental cleaning device 1010 may be configured in an elongated or bundled configuration to fit inside a rectangular-shaped pocket, or any other shape of pocket. It should further be appreciated that the pocket 1020 may be a one-layer pocket, wherein at least a portion of which is sealed directly to the container 1000, such that the dental cleaning device 1010 is housed between the pocket 1020 and the container 1000. The pocket 1020 is attached directly to the container 1000 by adhesive or heat melting, or by other suitable attachment means. Such a configuration of a sealed pocket 1020 preserves the hygiene of the dental cleaning device 1010, while also eliminating waste by eliminating one side of a standard two-layer packaging.

Referring now to FIG. 11, in another embodiment of the invention, the container 1100 is a disposable, open-ended container 1100 having a rim 1120 and an upper, open end 1140 that is not closable, wherein the container is designed and configured to enclose or support food, such as popcorn or other fast food. The dental cleaning device 1110 may be configured to longitudinally extend along at least a portion of the container 1100 proximal to the rim 1120 of the container, such that the user can conveniently use the dental floss to clean the popcorn lodged between the user's teeth during or immediately after eating the popcorn to provide quick and easy dental hygiene for the user at the location of popcorn consumption.

The dental cleaning device 1110 may be releasably attached to the container 1100 by any suitable attachment means, for example, by adhesive, or by being integrated into the container 1100, or otherwise disposed or partially disposed in the container 1100. As non-limiting examples, the dental cleaning device 1110 may be sewn into a container wall or disposed between two plies of a container wall. The dental cleaning device 1110 may further include a tab 1130 for pulling the dental cleaning device 1110 from the container 1100.

In this embodiment, the container 1100 is shown as a food “bucket,” such as a popcorn or fast food bucket; however, it should be appreciated that other containers having an open end that is not closable are also within the scope of the disclosure. For example, other bags and boxes designed to contain food, such as those seen in FIGS. 1, 3, and 6 are also within the scope of the disclosure. Moreover, containers such as those seen in FIGS. 7-10 may be filled with food so that they cannot be closed. Therefore, containers filled with food so as to not be closeable are also deemed to have an open end that is not closeable in accordance with embodiments described herein.

It should be appreciated that the dental cleaning device 1110 shown in FIG. 11 may be configured to be proximal to the rim 1120 of the container, such that a user can conveniently locate the dental cleaning device 1110 in dark venues, such as movie theatres. However, it should be appreciated that the dental cleaning device need not be proximal to the rim of the container, but may be located on any suitable surface of the container. It should further be appreciated that the dental cleaning device may also be the rim of the container. In addition, noise-making wrappers have been eliminated in the illustrated embodiment, to ensure minimal interruption to others watching the movie.

Referring now to FIG. 12, in another embodiment of the invention, the container 1200 is similar to the container shown in FIG. 11. In the illustrated embodiment, the dental cleaning device 1210 is configured to longitudinally extend along at least a portion of the container 1200 proximal to the rim 1220 of the container 1200. However, it should be appreciated that the dental cleaning device need not be proximal to the rim of the container, but may be located on any suitable surface of the container. The dental cleaning device 1210 of the illustrated embodiment is further configured to include a protective cover 1250, such as pressed plastic, tape, or wax cover. As a non-limiting example, the protective cover 1250 may be a peel-away protective cover that can be peeled from the container 1200 to reveal the dental cleaning device 1210 underneath the protective cover 1250. As another non-limiting example, the dental cleaning device 1240 may be peeled from under the protective cover 1250 by either breaking the film of the protective cover or by peeling the dental cleaning device 1240 from the protective cover 1250 together with the protective cover 1250. The protective cover 1250 may optionally include a pull tab to assist in pulling the protective cover 1240 from the container 1200.

Suitable protective covers preserve the hygiene of the dental cleaning devices. Moreover, suitable protective covers are suitably configured as a wax or tape cover to eliminate noise-making wrappers and ensure minimal interruption to others watching the movie. In addition, suitable protective covers are made from one layer of film, such that the protective covers form a pocket when attached to the container and eliminate unnecessary waste and noise-making that two layer packets may create.

Unless the context clearly requires otherwise, throughout the description in the following examples, the words comprise, comprising, and the like are to be construed in an inclusive sense as opposed to an exclusive or exhaustive sense; that is to say in the sense of “including, but not limited to.” Words using the singular or plural number also include the plural or singular number, respectively. Additionally, the words “herein,” “above,” and “below” and words of similar import, when used in this application, shall refer to this application as a whole and not to any particular portions of this application.

The description of embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. For example, while certain features are presented above in a given order, alternative embodiments may include such features in a different relationship than that described above. For example, although one or more of the foregoing embodiments may illustrate a dental cleaning device or other item affixed to an exterior portion of a food container, in other embodiments, such items can be affixed to an interior portion. The teachings of the invention provided herein can be applied to other products, not only the food products described herein. For example, a tooth pick or dental floss may be attached to the stick used with caramelized apples or corn dogs or a tooth pick or dental floss may be taped or otherwise attached to the exterior or interior (perhaps under the lid) of a Styrofoam food container having a compartmentalized base and integrally hinged lid commonly used at take-out delis or buffets. The various embodiments described herein can be combined to provide further embodiments. Further, aspects of the invention can be modified, if necessary, to employ the features described above in yet further embodiments. These and other changes can be made in the invention in light of the above detailed description.

While the preferred embodiment of the invention has been illustrated and described, it will be appreciated that various changes can be made therein without departing from the spirit and scope of the invention.

1. A popcorn container assembly, comprising:
(a) a disposable, open-ended popcorn container having a rim and an upper, open end that is not closable, wherein the container is designed and configured to enclose or support popcorn;
(b) a dental flossing device longitudinally extending along at least a portion of the container proximal to the rim of the container, such that the user can conveniently use the dental floss to clean the popcorn lodged between the user's teeth during or immediately after eating the popcorn to provide quick and easy dental hygiene for the user at the location of popcorn consumption; and
(c) popcorn at least partially disposed within the container.

2. The food container assembly of claim 1, wherein the dental flossing device is releasably attached to the container.

3. The food container assembly of claim 1, wherein the dental flossing device is securely attached to the container.

4. The food container assembly of claim 1, wherein the dental flossing device is the rim of the container.

5. The food container assembly of claim 1, wherein the dental flossing device is a strand of dental floss or dental tape.

6. The food container assembly of claim 1, wherein the dental flossing device is disposed in a pocket attached to the container.

7. The food container assembly of claim 1, wherein the dental flossing device is covered by a protective cover.

8. A food container assembly, comprising:
(a) a disposable food container having an edge and an upper, open end, wherein the container is designed and configured to enclose or support food;
(b) a dental flossing device longitudinally extending along at least a portion of the edge of the container, such that the user can use the dental flossing device to clean food lodged between the user's teeth during or immediately after eating the food at the location of food consumption, wherein the dental flossing device is the edge of the container; and
(c) food at least partially disposed within the container.

9. The food container assembly of claim 8, wherein the dental flossing device is releasably mounted along at least a portion of the container proximal to the edge of the container.

10. The food container assembly of claim 8, wherein the dental flossing device is securely mounted along at least a portion of the container proximal to the edge of the container.

11. The food container assembly of claim 8, wherein the dental flossing device is a strand of dental floss or dental tape.

13. The food container assembly of claim 8, wherein the dental flossing device is covered by a protective cover.

14. A food container assembly, comprising:
(a) a disposable, open-ended fast food container having an edge and an upper, open end that is not closable, wherein the container is designed and configured to enclose or support fast food and wherein the fast food is of the type sold for immediate consumption and, when consumed, has a tendency to get lodged between a user's teeth;
(b) at least a portion of a strand of dental floss longitudinally extending along at least a portion of the container proximal to the edge of the container, such that the user can use the strand of dental floss during or immediately after eating the fast food at the location of fast food consumption; and
(c) perishable fast food at least partially disposed within the fast food container.

15. The food container assembly of claim 14, wherein the at least a portion of the strand of dental floss is releasably attached to at least a portion of the fast food container proximal to the edge of the fast food container.

16. The food container assembly of claim 14, wherein the at least a portion of the strand of dental floss is securely attached to at least a portion of the fast food container proximal to the edge of the fast food container.

17. The food container assembly of claim 14, wherein the at least a portion of the strand of dental floss is integrated into the edge of the fast food container.

18. The food container assembly of claim 14, wherein the dental flossing device is a strand of dental floss or dental tape.

19. The food container assembly of claim 14, wherein the dental flossing device is disposed in a pocket attached to the container.

20. The food container assembly of claim 14, wherein the dental flossing device is covered by a protective cover.
